(19) United States
(12) Patent Application Publication
(10) Pub. No.: US 2021/0209930 A1
(43) Pub. Date: Jul. 8, 2021

(54) SMART HOME SECURITY SYSTEM AND METHOD OF DISARMING A SECURITY SETTING

(71) Applicant: Climax Technology Co., Ltd., Taipei (TW)

(72) Inventors: Yi-Kai Chen, Taipei City (TW); Tang Hui Liu, Taipei City (TW)

(21) Appl. No.: 16/736,576

(22) Filed: Jan. 7, 2020

(51) Int. Cl. G08B 25/00; G06K 9/00

(52) U.S. Cl. CPC G08B 25/008; G06K 9/00288; G06K 9/00912; G06K 9/00255

(57) ABSTRACT

A method of disarming a smart home security setting includes displaying a prompt page for instructing a user to proceed with facial image capture; capturing at least one face image of the user; allowing the user to enter a password only when an area ratio of captured face on the face image to a whole face is greater than a predetermined first threshold and an image quality of the face image is greater than a predetermined second threshold; and issuing a warning notification if identification according to the password fails.

### BACKGROUND OF THE INVENTION

### 1. Field of the Invention

The present invention generally relates to a security system, and more particularly to a method of disarming a security setting.

### 2. Description of Related Art

A smart home network is a computer network that connects electronic devices in a house via wired or wireless communication to interact with each other or create more functions. The smart home network, for example, may construct a smart home security system, the security setting of which may be armed via a gateway when the user leaves home, and may be disarmed when the user returns home. During the period between arm and disarm, the user may be notified by message, email or phone when any security device is triggered.

In a conventional security system, a user may disarm the security setting by entering a password, which however is liable to theft or break. Moreover, there is no way of being aware of the intruder when the security setting is unlawfully disarmed.

A need has thus arisen to propose a novel security scheme to overcome the drawbacks of the conventional security system.

### SUMMARY OF THE INVENTION

In view of the foregoing, it is an object of the embodiment of the present invention to provide a method of disarming a smart home security setting according to facial detection in addition to password identification, thereby enhancing security and recognizing intruder's appearance.

According to a method of disarming a smart home security setting in one embodiment, a prompt page for instructing a user to proceed with facial image capture is displayed, and at least one face image of the user is captured. The user is allowed to enter a password only when an area ratio of captured face on the face image to a whole face is greater than a predetermined first threshold and an image quality of the face image is greater than a predetermined second threshold. A warning notification is issued if identification according to the password fails.

### BRIEF DESCRIPTION OF THE DRAWINGS

FIG. 1 shows a block diagram illustrating a smart home security system according to one embodiment of the present invention;

FIG. 2 shows a flow diagram illustrating a method of disarming a smart home security setting according to one embodiment of the present invention;

FIG. 3A shows an exemplary prompt page of the input-output device; and

FIG. 3B shows an exemplary unlock page of the input-output device.

### DETAILED DESCRIPTION OF THE INVENTION

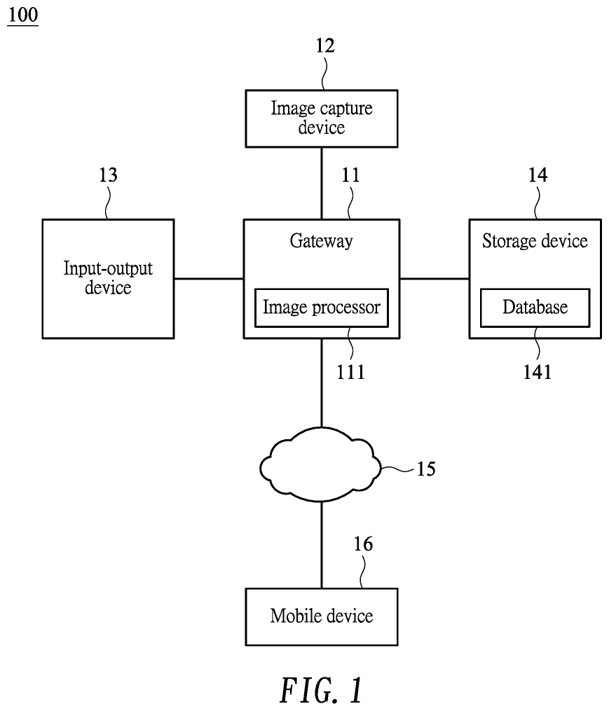

FIG. 1 shows a block diagram illustrating a smart home security system 100 according to one embodiment of the present invention. The smart home security system (security system hereinafter) 100 of the embodiment may include a gateway 11, an image capture device 12, an input-output device 13 and a storage device 14. In the embodiment, the gateway 11 is used as a server in a smart home network to control the image capture device 12, the input-output device 13 and the storage device 14. Further, the gateway 11 may include an image processor 111 configured to perform image processing. In one embodiment, the image capture device 12 may include a camera; the input-output device 13 may include a touch screen; and the storage device 14 may include a memory device configured to store a database 141 and temporary data. The image capture device 12 may, for example, be disposed in the input-output device 13.

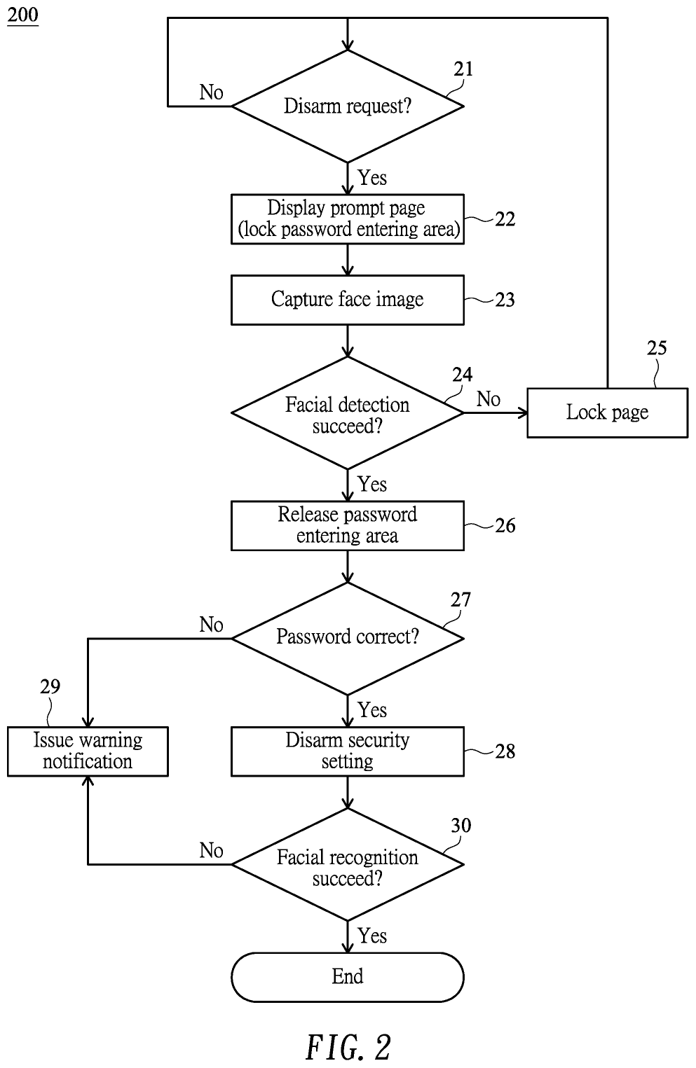

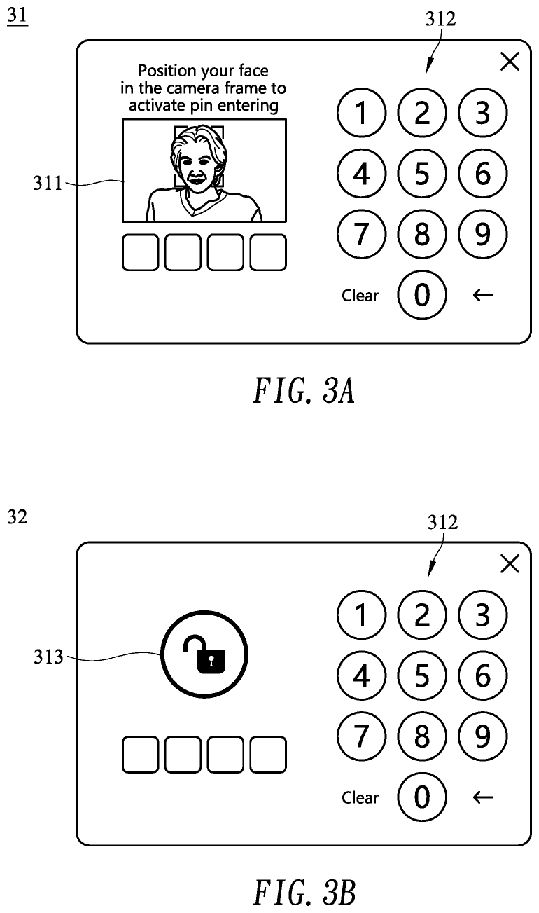

FIG. 2 shows a flow diagram illustrating a method 200 of disarming a smart home security setting according to one embodiment of the present invention, adaptable to a smart home network such as the security system 100 as shown in FIG. 1. In step 21, the gateway 11 may determine whether a disarm request is received. In one embodiment, a user may activate the input-output device 13 (e.g., touch the touch screen of the input-output device 13) when disarming the security setting. When the input-output device 13 receives the disarm request, a signal may be sent to notify the gateway 11. Accordingly, the gateway 11 may control the input-output device 13 to display a prompt page (step 22) for instructing the user to proceed with facial image capture by facing the image capture device 12 (or the input-output device 13). FIG. 3A shows an exemplary prompt page 31 of the input-output device 13. Specifically, in the embodiment, the prompt page 31 may include a current image area 311 that displays a current image captured by the image capture device 12. The prompt page 31 may also include a password entering area 312 through which the user may enter a predetermined password for identification.

In step 23, the gateway 11 may control the image capture device 12 to capture at least one face image of the user. If no image that substantially includes whole face and is clear has been captured, the image capture device 12 may continuously perform image capture until a predetermined first period (e.g., 30 seconds) lapses. In the specification, the term “whole” face means that a substantial portion (e.g., 90%) of face lies inside the image captured by the image capture device 12, or alternative speaking, an area ratio of captured face on the face image to a whole face is greater than a predetermined (first) threshold; and the term “clear” image refers to a captured image that can be sufficiently processed by the image processor 111, or alternatively speaking, an image quality of the face image is greater than a predetermined (second) threshold. According to one aspect of the embodiment, before an image that substantially includes whole face and is clear has been captured, the password entering area 312 of the input-output device 13 may be locked by the gateway 11 to prevent the user from entering a password.

In step 24, it determines whether the captured face image substantially includes whole face and is clear, that is, it determines whether facial detection succeeds. If the determination of step 24 is negative and a predetermined first period (e.g., 30 seconds) lapses, the gateway 11 may lock the (entire prompt) page on the touch screen of the input-output device 13 (step 25) to render it inactive. After a predetermined second period (e.g., 3 minutes) lapses, the flow goes back to step 21. If the determination of step 24 is positive, the gateway 11 may release the password entering area 312 of the input-output device 13 (step 26) to allow the user to enter a password through the password entering area 312, and the captured face image substantially including whole face and being clear may be stored in the storage device 14. Accordingly, the touch screen of the input-output device 13 may display an unlock page 32. FIG. 3B shows an exemplary unlock page 32 of the input-output device 13, on which the current image area 311 is replaced with an unlock notification 313.

In step 27, the gateway 11 may determine whether identification of the password entered by the user is correct, for example, by comparing it with a password stored beforehand in the storage device 14. If the password identification in step 27 fails (indicating that the current user has no qualification to disarm the security setting), the gateway 11 may issue a warning notification to a mobile device 16 of an associated person (e.g., administrator of the smart home network) via the network 15 such as Internet (step 29). At the same time, the captured face image of the user may be sent or stored in the storage device 14.

If the password identification in step 27 succeeds, indicating that the current user passes the facial detection and password identification, the gateway 11 may disarm the security setting (step 28) of the smart home network. In one embodiment, the gateway 11 may store the captured face image of the user in the storage device 14 or send the captured face image to the associated person after disarming the security setting.

In one embodiment, in step 30, the image processor 111 of the gateway 11 may further perform facial recognition according to the captured face image and a database 141 stored beforehand in the storage device 14. Specifically, the database 141 may store beforehand facial image data (e.g., facial image features) of at least one admissible user. The image processor 111 of the embodiment may perform facial recognition by using conventional facial recognition techniques, details of which are omitted for brevity.

If the facial recognition in step 30 fails (indicating that the current user has no qualification to disarm the security setting), in step 29, the gateway 11 may issue a warning notification to the mobile device 16 of the associated person (e.g., administrator of the smart home network) via the network 15 (e.g., Internet). At the same time, the captured face image of the user may be sent or stored in the storage device 14.

Although specific embodiments have been illustrated and described, it will be appreciated by those skilled in the art that various modifications may be made without departing from the scope of the present invention, which is intended to be limited solely by the appended claims.

What is claimed is:

1. A method of disarming a smart home security setting, comprising:
displaying a prompt page for instructing a user to proceed with facial image capture;
capturing at least one face image of the user;
allowing the user to enter a password only when an area ratio of captured face on the face image to a whole face is greater than a predetermined first threshold and an image quality of the face image is greater than a predetermined second threshold; and
issuing a warning notification if identification according to the password fails.

2. The method of claim 1, further comprising:
sending or storing the face image when issuing the warning notification.

3. The method of claim 1, wherein the prompt page comprises:
a current image area that display a current image of the user; and
a password entering area through which the user enters the password.

4. The method of claim 3, wherein the password entering area is locked until the area ratio is greater than the first threshold and the image quality is greater than the second threshold.

5. The method of claim 1, further comprising:
receiving a disarm request associated with the smart home security setting before displaying the prompt page.

6. The method of claim 1, further comprising:
locking the prompt page when the area ratio is not greater than the first threshold or the image quality is not greater than the second threshold, and a predetermined period lapses.

7. The method of claim 1, wherein the warning notification is issued via a network.

8. The method of claim 1, wherein the smart home security setting is disarmed when the identification succeeds.

9. The method of claim 8, further comprising:
sending or storing the face image when disarming the smart home security setting.

10. The method of claim 8, further comprising:
performing facial recognition on the face image after disarming the smart home security setting.

11. A smart home security system, comprising:
a gateway;
an input-output device that displays a prompt page for instructing a user to proceed with facial image capture; and
an image capture device that captures at least one face image of the user;
wherein the user is allowed to enter a password only when an area ratio of captured face on the face image to a whole face is greater than a predetermined first threshold and an image quality of the face image is greater than a predetermined second threshold; and a warning notification is issued if identification according to the password fails.

12. The system of claim 11, further comprising:
a storage device that stores the face image;
wherein the gateway sends or stores the face image when issuing the warning notification.

13. The system of claim 11, wherein the prompt page comprises:
a current image area that display a current image of the user; and
a password entering area through which the user enters the password.

14. The system of claim 13, wherein the password entering area is locked until the area ratio is greater than the first threshold and the image quality is greater than the second threshold.

15. The system of claim 11, wherein the input-output device receives a disarm request associated with a smart home security setting before displaying the prompt page.

16. The system of claim 11, wherein the prompt page is locked when the area ratio is not greater than the first threshold or the image quality is not greater than the second threshold, and a predetermined period lapses.

17. The system of claim 11, further comprising:
a network via which the warning notification is issued by the gateway.

18. The system of claim 11, wherein a smart home security setting is disarmed by the gateway when the identification succeed.

19. The system of claim 18, wherein the face image is sent or stored when disarming the security setting.

20. The system of claim 18, wherein the gateway performs facial recognition on the face image after disarming the smart home security setting.
